(19) United States
(12) Patent Application Publication
(10) Pub. No.: US 2022/0303618 A1
(43) Pub. Date: Sep. 22, 2022

(54) SYSTEMS, METHODS, AND APPARATUSES FOR PROCESSING VIEWERSHIP INFORMATION

(71) Applicant: Comcast Cable Communications, LLC, Philadelphia, PA (US)

(72) Inventors: Christopher Whitely, New York, NY (US); Robert Bress, New York, NY (US); Zhao Xing, New York, NY (US)

(21) Appl. No.: 17/204,266

(22) Filed: Mar. 17, 2021

(51) Int. Cl. H04N 21/442; H04N 21/482

(52) U.S. Cl. CPC H04N 21/44204; H04N 21/4821; H04N 21/44222; H04N 21/44218

(57) ABSTRACT

Methods, systems, and apparatuses for content viewership statistic adjustment are described herein. Content viewership data is analyzed. A start time and an end time of a delivery of a content item in a content viewing session is determined based on the analysis. A false positive viewing event is determined based on a comparison between a viewing characteristic of the content viewing session and a threshold. The determined false positive viewing event is removed from a viewership statistic.

### BACKGROUND

Viewership statistics reflect the viewership (e.g., number of viewers, regions, length of viewing time, etc.) of content (e.g., a content item), such as content provided by a content provider. A device (e.g., set top box) that receives the content may track viewership, however, the device may yield viewership statistics that are inaccurate. Viewership statistics from the device may include false positive viewing events resulting from credit given for viewing events that do not involve a user actually viewing content. For example, credit may be given for a viewing event when the set top box is powered on but the television associated with the set top box is powered off. Adjustment to such viewership statistics based on detection of false positive viewing events may enable more accurate viewership statistics. More accurate viewership statistics may improve analysis of content viewership and targeted delivery of content items. These and other considerations are addressed herein.

### SUMMARY

It is to be understood that both the following general description and the following detailed description are exemplary and explanatory only and are not restrictive, as claimed. Methods, systems, and apparatuses for adjustment of viewership statistics for content items are described herein. A viewership statistic may be generated for a content item provided by a content provider. For example, the viewership statistic may indicate how many viewers have watched the content item and/or provide a summary of viewership events for the content item. A viewership event may be, for example, a content viewing session, a set top box power on event, a connection by a display/output device (e.g., a smartphone) to a content provider for receiving content, a selection on a user interface (e.g., pressing a button on a remote control, selecting a program guide on a television), and/or the like. The viewership statistic may be generated based on raw viewership data and, as a consequence, may include false positive viewing events. Disclosed are methods and systems configured to remove these false positive viewing events to improve the accuracy of the viewership statistic. One or more characteristics of a viewing event (e.g., a viewing characteristic) may be determined and compared to a threshold to identify a viewing event as a false positive viewing events. In this way, false positive viewership events resulting from, for example, an excessive amount of time tuned to a television channel, a tune to a television channel in which no viewer is watching the television, or an unreliable reporting device (e.g., set top box) may be detected and removed from raw viewership event data.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 shows an example environment in which the present methods and systems may operate;

FIG. 2 shows an example environment in which the present methods and systems may operate;

FIG. 3 shows a flowchart of an example method;

FIGS. 4A-4C show example viewership statistic data;

FIG. 5 shows example graphs;

FIG. 6 shows an example graph;

FIG. 7 shows an example graph;

FIG. 8 shows a flowchart of an example method;

FIG. 9 shows a flowchart of an example method;

FIG. 10 shows a flowchart of an example method; and

FIG. 11 shows a block diagram of an example computing device in which the present methods and systems may operate.

### DETAILED DESCRIPTION

Before the present methods and systems are described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Described are components that may be used to perform the described methods and systems. These and other components are described herein, and it is understood that when combinations, subsets, interactions, groups, etc. of these components are described that while specific reference of each various individual and collective combinations and permutation of these may not be explicitly described, each is specifically contemplated and described herein, for all methods and systems. This applies to all aspects of this application including, but not limited to, steps in described methods. Thus, if there are a variety of additional steps that may be performed it is understood that each of these additional steps may be performed with any specific embodiment or combination of embodiments of the described methods.

The present methods and systems may be understood more readily by reference to the following detailed description and the examples included therein and to the Figures and their previous and following description. As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, flash memory internal or removable, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

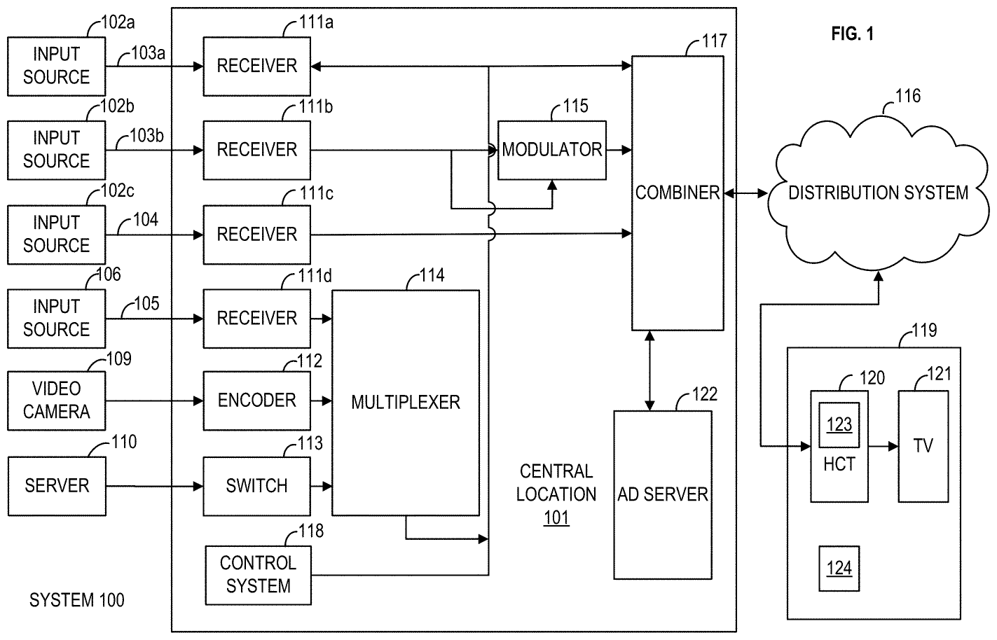

FIG. 1 illustrates various aspects of an example environment in which the present methods and systems can operate. The environment is relevant to systems and methods for adjustment of viewership statistics for content items provided by a content provider. Those skilled in the art will appreciate that present methods may be used in systems that employ both digital and analog equipment. One skilled in the art will appreciate that provided herein is a functional description and that the respective functions can be performed by software, hardware, or a combination of software and hardware.

The system 100 can comprise a central location 101 (e.g., a headend), which can receive content (e.g., data, input programming, and the like) from multiple sources. The central location 101 can combine the content from the various sources and can distribute the content to user (e.g., subscriber) locations (e.g., location 119) via distribution system 116. A data management platform or content provider may gather viewership data based on the distribution of the content to various user locations. Information (e.g., viewership data) related to the consumption of provided content (e.g., content items) may be collected. For example, the data management platform or content provider may measure the audience for various content items of the distributed content. As an example, the data management platform or content provider may analyze viewership data to determine what distributed content is viewed by which viewers and when the viewing occurs.

As an example, the data management platform or content provider may analyze viewership data to viewership statistics that may comprise information of a number of viewers of certain distributed content, viewership ratings information, demographic information and/or the like. For example, viewership data may relate to what content was/is being viewed, who was/is viewing the content, how long the content was viewed, what devices are being used to view the content, descriptive information regarding the content (e.g., content rating, genre, audience approval rating, etc.), and/or the like. The viewership data may be used to generate viewership statistics. The viewership data may correspond to a content viewing session. An instance of a user (e.g., a viewer) viewing content may be referred to as a content viewing session. A content viewing session may define a continuous length of time in which a viewer actually watches one or more content items (e.g., a 2 hour viewing session during which the viewer watches a movie).

The viewership data may comprise viewership events (e.g., viewing event). A viewing event may be, for example, a content viewing session, a user device power on event (e.g., powering on a set top box), a user device power off event, a connection being formed by a display/output device (e.g., a smartphone) for receiving content, a selection on a user interface (e.g., pressing a button on a remote control, selecting a program guide on a television), and/or the like. If the viewership data contains a false positive viewing event, the resulting viewership statistics being generated may be inaccurate. A false positive viewing event may be a content viewing event in which a content viewing device (e.g., set top box, television) is powered on, but no viewer is viewing content on the content viewing device during the content viewing event. Accordingly, removing the false positive viewing events may improve the accuracy of the corresponding viewership statistics. Examples of false positive viewing events may be, for example, the user device is powered on but the associated television is off, a viewer leaves a room after watching content but forgets to turn off the user device, the viewer starts watching a content item on a display device but stops without powering off the display device, an application or guide graphical element is overlaid onto a television channel being output/displayed, and/or the like. The false positive viewing events may be reflected in viewership data reported by a reporting device (e.g., a set top box that receives numerous content items). The viewership data reported by the reporting device may be inconsistent with other methods of collecting viewership data (e.g., panel-based reporting or automatic content recognition). A false positive viewing event may be determined to correspond to one or more content items.

The central location 101 can receive content from a variety of input sources 102a, 102b, 102c. The content can be transmitted from the source to the central location 101 via a variety of transmission paths, including wireless (e.g. satellite paths 103a, 103b) and terrestrial path 104. The central location 101 can also receive content from a direct feed input source 106 via a direct line 105. Other input sources can comprise capture devices such as a video camera 109 or a server 110. The signals provided by the content sources can include a single content item or a multiplex that includes several content items. The server 110 may store viewership data, resulting viewership statistics (e.g., raw or generated viewership statistics based on data from the data management platform), software for executing a capping algorithm, and/or the like. For example, the resulting viewership statistics may be an average amount of time a content item was viewed by various viewers, demographic statistics (e.g., the number of viewers in the 18-29 age range who viewed the content item), a viewership rating, when the content item was viewed (e.g., morning, evening, some other time of day), and/or the like.

The central location 101 can comprise one or a plurality of receivers 111a, 111b, 111c, 111d that are each associated with an input source. For example, MPEG encoders such as encoder 112, are included for encoding local content or a video camera 109 feed. A switch 113 can provide access to server 110, which can be a Pay-Per-View server, a data server, an Internet router, a network system, a phone system, and the like. Some signals may require additional processing, such as signal multiplexing, prior to being modulated. Such multiplexing can be performed by multiplexer (mux) 114. For example, the multiplexing may be performed to switch between streaming content (e.g., over the Internet), Pay-Per-View content, cable television content, and/or the like.

The central location 101 can comprise one or a plurality of modulators 115 for interfacing to the distribution system 116. The modulators can convert the received content into a modulated output signal suitable for transmission over the distribution system 116. The output signals from the modulators can be combined, using equipment such as a combiner 117, for input into the distribution system 116.

A control system 118 can permit a system operator to control and monitor the functions and performance of system 100. The control system 118 can interface, monitor, and/or control a variety of functions, including, but not limited to, the channel lineup for the television system, billing for each user, conditional access for content distributed to users, and the like. Control system 118 can provide input to the modulators for setting operating parameters, such as system specific MPEG table packet organization or conditional access information. The control system 118 can be located at the central location 101 or at a remote location. The control system 118 may provide viewership data and information. For example, the control system 118 may determine or send viewership events (e.g., content viewing sessions) based on monitoring or controlling access to content distributed to users and/or user selected television channels. The control system 118 may determine viewership statistics based on the viewership events. As an example, a data source device may be a component of the control system 118 for providing viewership data and information. The data source device may be located at the central location 101 or located remotely (e.g., as part of a remote portion of the control system 118).

The distribution system 116 can distribute signals from the central location 101 to user locations, such as user location 119. The distribution system 116 can be an optical fiber network, a coaxial cable network, a hybrid fiber-coaxial network, a wireless network, a satellite system, a direct broadcast system, or any combination thereof. There can be a multitude of user locations connected to distribution system 116. For example, a user location may correspond to a residential home. At a user location 119, a network device, such as a gateway or home communications terminal (HCT) 120 can decode, if needed, the signals for display on one or more display device, such as on a display 121, such as a television set (TV) or a computer monitor. The one or more display devices may be monitored to receive or gather viewership data, such as information on viewership events associated with specific viewers in the residential home. Those skilled in the art will appreciate that the signal can be decoded in a variety of equipment, including an HCT, a computer, a TV, a monitor, or satellite dish. Viewership statistics may be determined and/or analyzed by devices that are located within or are a component of one or more HCT's 120, displays 121, central locations 101, DVR's, home theater PC's, and the like. The one or more HCT's 120 can transmit signals to create zones. an HCT 120 can broadcast a Bluetooth beacon to determine where a responding device is located within particular zone. For example, a user device responding to a Bluetooth beacon may be used to determine that a user possessing the user device is located in a living room where the user is watching the television (e.g., part of a viewership event such as a content viewing session). The user location 119 may not be fixed. By way of example, a user can receive content from the distribution system 116 on a mobile device such as a laptop computer, PDA, smartphone, GPS, vehicle entertainment system, portable media player, and the like.

The methods and systems disclosed can be performed by one or more HCT's 120. For example, the HCT 120 may execute computer executable instructions to execute a suitable capping algorithm. This way, the HCT 120 may determine false positive viewing events and adjust viewership statistics associated with the false positive viewing events. For example, the HCT 120 may remove or adjust credit for a viewership statistic associated with a content viewing session or viewership event based on the determination of a corresponding false positive viewing event (e.g., based on a duration of the content viewing session or viewership event exceeding a threshold). Execution of the capping algorithm may involve comparing the duration to the threshold. The HCT 120 can be in communication with one or more user devices 124 that may be used to view content during a viewing/viewership event. The HCT 120 can have logic 123. The logic 123 in the HCT 120 can monitor the content presented on the display 121 to determine viewership data, determine viewership statistics, and/or adjust viewership statistics.

The HCT 120 may classify or label a viewing event as a false positive viewing event by analyzing one or more viewing characteristics associated with the viewing event. A viewing characteristic may be a feature related to or indicative of a quality associated with viewing event. For example, the feature may indicate who is involved in the viewing event, how a viewer of the viewing event differs from viewers of other similar viewing events, what equipment (e.g., television, set top box, smart phone) is being used for the viewing event. As an example, the viewing characteristic may be a percentile rank of a viewing length of the content viewing session, an hour within a twenty four hour period, or historic viewing length data, a set top box classification, and/or the like. The viewing characteristic may be determined based on viewership data received from a data management platform or Automatic Content Recognition (ACR) feed, for example. The viewing characteristic may be used for identification of a false positive viewing event. As an example, the viewing characteristic may be input into a capping algorithm that is used to determine the false positive viewing event.

A capping algorithm may be a method to determine a maximum cap or length of time associated with a viewing event. The capping algorithm may be, for example, a percentile capping algorithm, a time variant capping algorithm, a device classification algorithm, a suitable capping algorithm, and/or some combination thereof. As an example, the percentile capping algorithm may use the viewing characteristic of a statistical distribution of respective durations of various content viewing sessions to determine a threshold (e.g., percentile cap threshold). For example, the 80^{th} percentile may be used to set the threshold as a threshold maximum session length of 60 minutes. The value of the threshold may depend on when a corresponding viewing event (e.g., content viewing session) begins. As an example, a time variant capping algorithm may be used to determine the threshold (e.g., time variant threshold). The threshold may be based on the viewing characteristic of a time of a day of a viewing event. A content viewing session beginning at 6:00 pm may have a threshold value of 140 minutes while another content viewing session beginning at 6:00 pm may have a different threshold value of 130 minutes. As an example, a device classification algorithm may be used to determine the threshold. The threshold may be determined based on the viewing characteristic of device classification (e.g., classification of set top box) such as a “good” classification and a “bad” classification. A “good” device may refer to a device with high reporting reliability while a “bad” device may refer to a device with low reporting reliability.

Depending on what capping algorithm is used to determine the threshold, the threshold may be determined based on temporal information (e.g., a time of the day), a network type, a percentile, historical viewership data, an expected duration of a content viewing session, power usage data, and/or the like. The false positive viewing events identified by comparison of the viewing characteristic (e.g., characteristic of viewership event used to generate the raw viewership statistic) to the determined threshold may be removed from the raw viewership statistic to determine a more accurate adjusted viewership statistic. The false positive viewing events may be removed from the viewership data used to generate viewership statistics. Execution of a capping algorithm may identify false positive viewing events and/or adjust a viewing statistic for a particular content item or a particular television channel. For example, a viewing statistic corresponding to a content viewing session of the television channel and that spans 8 pm to 6 am may be adjusted or edited so that credit for the 8 pm to 6 am content viewing session is removed or reduced when generating the viewing statistic. Based on using more accurate viewing statistics, advertisers may be billed more accurately.

The false positive viewing event may be removed from a corresponding viewership statistic or viewership data. For example, credit for the false positive viewing event may be removed by applying a threshold (e.g., cap threshold or maximum threshold) to a raw viewership statistic (e.g., threshold applied to the viewership event of viewership data used to generate the raw viewership statistic). For example, the raw viewership statistic may be edited by setting or changing a maximum session length parameter for a corresponding viewership event (e.g., content viewing session).

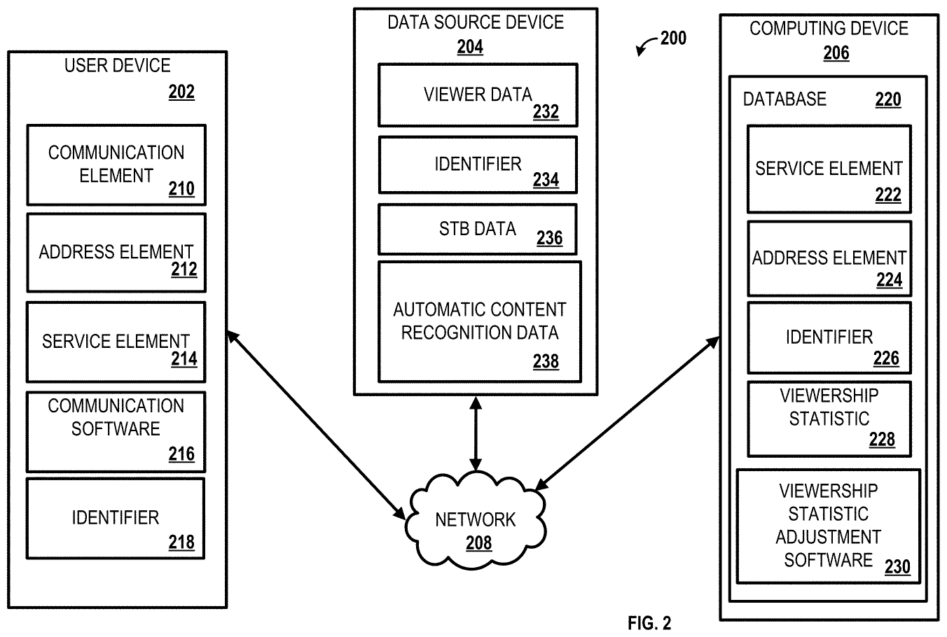

FIG. 2 shows an example environment 200 for content viewership statistic adjustment in which the present methods and systems can operate. Those skilled in the art will appreciate that digital equipment and/or analog equipment may be employed. One skilled in the art will appreciate that provided herein is a functional description and that the respective functions may be performed by software, hardware, or a combination of software and hardware.

The system 200 may include a user device 202, a data source device 204, and a computing device 206. The user device 202 may communicate with the data source device 204, and/or the computing device 206 via a network 208. The user device 202 may be or comprise a device capable of receiving and outputting content such as a mobile device (e.g., a smartphone, a telephone, a tablet), a television, a projector, a display screen, an output screen, a set top box, and/or the like. For example, the user device 202 may receive one or more content items on a particular content channel (e.g., television channel), on multiple content channels, or via streaming (e.g., via the Internet). For example, the user device 202 can receive instructions from a user via a user input (e.g., remote, keyboard, keypad) to switch from one content source to another content source, such as from one television channel to another television channel. The network 208 may support communication between user device 202, a data source device 204, and/or the computing device 206 via a short-range communications (e.g., BLUETOOTH®, near-field communication, infrared, Wi-Fi, etc.) and/or via a long-range communications (e.g., Internet, cellular, satellite, and the like). For example, the network 208 may utilize Internet Protocol Version 4 (IPv4) and/or Internet Protocol Version 6 (IPv6). The network 208 may be a telecommunications network, such as a mobile, landline, and/or Voice over Internet Protocol (VoIP) provider.

The user device 202 may include a communication element 210, an address element 212, a service element 214, communication software 216, and an identifier 218. The communication element 210 may be configured to communicate via any network protocol. For example, the communication element 210 may communicate via a wired network protocol (e.g., Ethernet, LAN, WAN, etc.) on a wired network (e.g., the network 208). The communication element 210 may include a wireless transceiver configured to send and receive wireless communications via a wireless network (e.g., the network 208). The wireless network may be a Wi-Fi network. The user device 202 may communicate with the data source device 204, and/or the computing device 206 and/or via the communication element 210. The communication element 210 of the user device 202 may be configured to communicate via one or more of second generation (2G), third generation (3G), fourth generation (4G), fifth generation (5G), GPRS, EDGE, D2D, M2M, long term evolution (LTE), long term evolution advanced (LTE-A), code division multiple access (CDMA), wideband code division multiple access (WCDMA), universal mobile telecommunications system (UMTS), wireless broadband (WiBro), Voice Over IP (VoIP), and global system for mobile communication (GSM). The communication element 210 of the user device 202 may further be configured for communication over a local area network connection through network access points using technologies such as IEEE 802.11.

The address element 212 may include or provide an internet protocol address, a network address, a media access control (MAC) address, an Internet address (e.g., an IPv4, an IPv6 address, etc.), or the like. The address element 212 may be used to establish a communication connection between the data source device 204, and/or the computing device 206 and/or networks such as the network 208. The address element 212 may be an identifier or locator of the user device 202. The address element 212 may be persistent for a particular network (e.g., the network 208). The service element 214 may include an identification of a service provider associated with the user device 202 and/or with the class of user device 202. For example, the service provider may provide Internet service, cable television service, satellite service, and/or the like. The class of the user device 202 may be related to a type of device, capability of device, type of service being provided, and/or a level of service (e.g., business class, service tier, service package, etc.). The service element 214 may include information relating to or provided by a service provider (e.g., Internet service provider, content service provider, communications service provider, etc.) that may provide or enable data flow such as communication services (e.g., a phone call, a video call, etc.) and/or content services to the user device 202. The service element 214 may include information relating to a preferred service provider for one or more particular services relating to the user device 202. The address element 212 may be used to identify or retrieve data from the service element 214, or vice versa. One or more of the address element 212 and/or the service element 214 may be stored remotely from the user device 202, such as in the database 220. Other information may be represented by the service element 214.

The user device 202 may include communication software 216. The communication software 216 may be software, firmware, hardware, and/or a combination of software, firmware, and hardware. The communication software 216 may allow the user device 202 to communicate or establish a communication session with one or more devices, such as the data source device 204 and/or the computing device 206 via the network 208. The data source device 204 and/or the computing device 206 may be part of the control system 118 (FIG. 1) and located at or remotely from the central location 101. The communication software 216 may be configured to send and/or receive data, communication services (e.g., a phone call, a video call, etc.), and so forth via the communication element 210. The recipient device 106 may further be configured for communication over a local area network connection through network access points using technologies such as IEEE 802.11. For example, the communication software 118 may be configured to establish a phone call and/or a video call with the recipient device 106. As an example, the communication software 118 may be configured to communicate with the message device 108 to leave one or more messages for another device (e.g., the recipient device 106) if the communication connection and/or the communication session is not established with the other device.

The user device 202 may be associated with a user identifier or device identifier 218. The device identifier 218 may be any identifier, token, character, string, or the like, for differentiating one user or user device (e.g., the user device 202) from another user or user device. For example, the device identifier 218 may be or relate to an Internet Protocol (IP) Address, a Media Access Control (MAC) address, an International Mobile Equipment Identity (IMEI) number, an International Mobile Subscriber Identity (IMSI) number, a phone number, a SIM card number, and/or the like. The device identifier 218 may identify a user or user device as belonging to a particular class of users or user devices. The device identifier 218 may include information relating to the user device 202 such as a manufacturer, a model or type of device, a service provider associated with the user device 202, a state of the user device 202, a locator, and/or a label or classifier. Other information may be represented by the device identifier 218.

The data source device 204 may include, generate, or store viewer data 232 (e.g., content viewership data), an identifier 234, set top box data 236, and automatic content recognition data 238. For example, the data source device 204 may receive the content viewership data 232 from a viewership data provider such as smart television content viewership data provider. The smart television content viewership data provider may use an automatic content recognition (ACR) technique to gather audience data with respect to various content items (e.g., content programs) being sent to various user devices. The smart television content viewing provider may be gathered via a smart television operator system designed by a smart television manufacturer, for example. The smart television content viewership data provider may be a data management platform that sends, in a feed, the content viewership data 232 and automatic content recognition (ACR) data 238 to the data source device 204. For example, the data source device 204 may comprise a set top box that generates the set top box data 236. The set top box may generate or report set top box data 236 comprising content viewership data 232 corresponding to the user device 202 (e.g., television) associated with the set top box. As an example, each set top box for each television may report what content items have been output and presumably viewed by a viewer and during which corresponding content viewing sessions. The data source device 204 may be provided at least one of: the content viewership data 232 of the set top box data 236, the content viewership data 232 of the smart television content viewership data provider, or the ACR data 238. The data source device 204 may be provided this data in parallel or not in parallel. The content viewership data 232 may include a viewership statistic such as a raw viewership statistic. The content viewership data 232 may be used to determine a start time of a delivery of a content item and an end time of the delivery of the content item. The identifier 234 may identify the data source device 204 in communications with the user device 202 and/or the computing device 206 via the network 208, for example.

The computing device 206 may manage the communication between the user device 202, the data source device 204 and/or a database 220 for sending and receiving data therebetween. The computing device 206 may comprise a database 220 for storing viewership information and data to adjust a viewership statistic 228. For example, the database 220 may store raw viewership statistics, a plurality of files (e.g., web pages), user/viewer identifiers or records, data associated with viewing content, and/or processor executable instructions for adjusting the raw viewership statistics. For example, the computing device 206 may execute processor executable instructions to compare a viewing characteristic to a threshold. For example, the comparison may indicate an instance of incorrect viewership monitoring, such as a false positive viewing event. Execution of the processor executable instructions may cause the computing device 206 to adjust a viewership statistic 218 based on the comparison, such as by removing the false positive viewing event from the viewership statistic 218. For example, the false positive viewing event may include the set top box is powered on but the associated television is off and no one is viewing content on the television, a viewer starts watching a content item but stops watching without powering off the set top box and/or the television, the viewer forgets to turn off the set top box so the set top box is powered on for an excessive disproportionate quantity of time, an application or guide graphical element is overlaid onto a displayed television channel, and/or the like.

The database 220 may include a service element 222, an address element 224, an identifier 226, a viewership statistic 228, and viewership statistic adjustment software 230. The service element 222 may include an identification of a service provider associated with the computing device 206 and/or with the class of computing device 206. The class of the computing device 206 may be related to a type of device, a capability of device, a type of service being provided, and/or a level of service (e.g., business class, service tier, service package, etc.). The service element 222 may include information relating to or provided by a communication service provider (e.g., Internet service provider, communications service provider, etc.) that is sending or receiving data flow such as communication services to or from the computing device 206. The service element 222 may include information relating to a preferred service provider for one or more particular services relating to the computing device 104. Other information may be represented by the service element 222.

The address element 224 may include or provide an internet protocol address, a network address, a media access control (MAC) address, an Internet address, or the like. The address element 224 may be relied upon to establish a communication session between the computing device 206 and the user device 202, the data source device 204, and/or other devices and/or networks. The address element 224 may be used as an identifier or locator of the computing device 206. The address element 224 may be persistent for a particular network. The computing device 206 may have an identifier 226. The identifier 226 may be or relate to an Internet Protocol (IP) Address, a Media Access Control (MAC) address, and/or the like. The identifier 226 may be a unique identifier for facilitating wired and/or wireless communications with the user device 202 and/or the data source device 204 such as via the network 208. The identifier 226 may be associated with a physical location of the computing device 104.

The database 220 may include a viewership statistic 228 for each content item of a plurality of content items. The viewership statistic 228 may reflect content item consumption behavior as well as device type associated with viewership of each content item. For example, the viewership statistic 228 for a content item or content program may indicate the number of viewers or audience members viewing the content item (e.g., television program, movie, etc.) or accessing the content item (e.g., accessing a website on the Internet) and the length of time the content item was viewed or accessed. Other audience measurement type data may be included in the viewership statistic 228. As an example, the viewership statistic 228 may include data indicative of an expected number of viewers of a content item, how the measured number of viewers compares to a related content item (e.g., two different episode of the same television series content item), a time that a content viewing session for the content item begins (e.g., morning, afternoon, evening), demographic statistics (e.g., content viewership based on age range), rating, and/or the like. For example, the viewership statistic 228 may include content metadata indicative of a start time of a delivery of a content item and an end time of the delivery of the content item. The content metadata may be received from the user device 202, for example. The viewership statistic 228 may be stored in the database 220 by the computing device 206. The computing device 206 may receive viewership statistics from the data source device 204. The computing device 206 may generate viewership statistics based on the content viewership data 232 of the set top box data 236, the content viewership data 232 of the smart television content viewership data provider, and/or the ACR data 238 received from the data source device 204.

The database 220 may include viewership statistic adjustment software 230 for adjusting each viewership statistic 228 as desired. The viewership statistic adjustment software 230 may comprise processor executable instructions for content viewership statistic adjustment. A viewing characteristic may be an input used for execution of the processor executable instructions. For example, for a specific content item, the viewing characteristic may be or be calculated based on a percentile rank of a length of a content viewing session for the specific content, a time at which the content viewing session occurs, historical power usage data of the user device 202, and/or the like. For example, the computing device 206 may adjust a viewership statistic 228 based on executing viewership statistic adjustment software 230 with respect to the content viewership data 232 of the set top box data 236, the content viewership data 232 of the smart television content viewership data provider, and/or the ACR data 238 received from the data source device 204. Execution of the viewership statistic adjustment software 230 may cause the computing device 206 may adjust a viewership statistic 228 by comparing the viewing characteristic to a threshold such as a maximum session length parameter. As an example, adjustment of the viewership statistic 228 may comprise removing a false positive viewing event form the viewership statistic 228. Adjustment of the viewership statistic 228 may comprise reducing an amount of credit given for a measured content viewing session for the content item associated with the viewership statistic 228. The amount of credit may be based on a duration of the measured content viewing session.

The user device 202 and/or the data source device 204 may request and/or retrieve a file, data, information, and/or the like from the database 220. For example, the user device 202 may request adjusted viewership statistics from the database 220 to indicate a relevant adjusted viewership statistic for a content item currently being output to a display of the user device 202. As an example, the display of the user device 202 may show a star rating indicating how popular an episode of a sitcom content item in which the star rating is determined based on the associated adjusted viewership statistic. For example, the data source device 204 may request viewership statistics or adjusted viewership statistics from the database 220 to assess the accuracy of the of the content viewership data 232 of the set top box data 236 and the content viewership data 232 of the smart television content viewership data provider. The database 220 may store information relating to the user device 202 such as the address element 212 and/or the service element 214. The computing device 206 may obtain the device identifier 218 from the user device 202 and retrieve information from the database 220. The computing device 206 may assign the identifier 218 to the user device 202. Any information may be stored in and retrieved from the database 220. The database 220 may be disposed remotely from the computing device 206 and accessed via direct or indirect connection. The database 220 may be integrated with the computing device 206 or some other device or system.

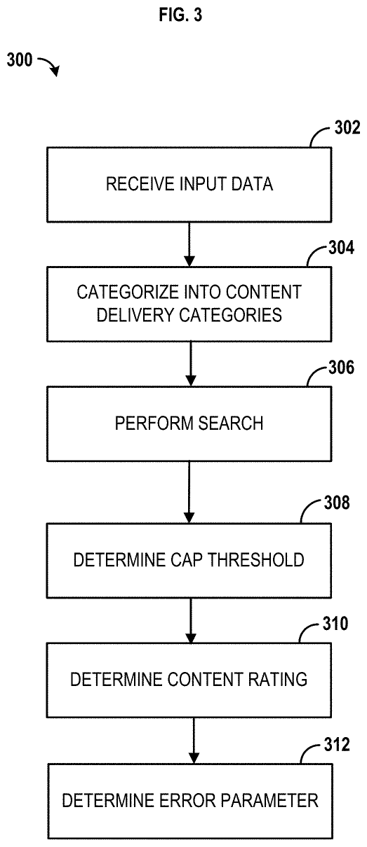

FIG. 3 shows a flowchart illustrating an example method 300 for content viewership statistic adjustment. The method 300 may be implemented using the devices shown in FIGS. 1-2. For example, the method 300 may be implemented using a device such as the computing device 206. At step 302, a computing device may receive input data such as content viewership data. The content viewership data may be arranged by a type or identity of content item. For example, the content viewership data may indicate a quantity and length of content viewing sessions for a basketball game content item output to or displayed on the ESPN television channel. The content viewership data may indicate the number of viewers for a content item as well as the duration of the associated content viewing sessions for the content item. Credit or some other numerical representation may be included in the content viewership data to account for the amount of time that a particular viewer watched a content item. As an example, a user device such as a television and/or set top box that is tuned to a movie for a content viewing session having a duration of 1 hour may be credited in the content viewership data for the movie for one hour instead of the full length of the movie. That is, the content viewership data may include viewing events indicating how many viewers' devices were receiving a particular content item and the duration of the content viewing session in which the particular content item was received. Viewing events may comprise content viewing sessions as well as reboot events, standby events, power off events, power on events, and/or the like.

The content viewership data may be received from various input sources such as a user device 202 (e.g., set top box, voice-controlled remote control, digital streaming device, smart speaker, Internet and television service enabled device), audience measurement service provider, smart television content viewership data provider and/or the like. The content viewership data may be scaled to account for missing devices. For example, devices capable of outputting content items and located in a particular residence may be inadvertently omitted from the content viewership data generated for that particular residence. The devices may be of a different type than a type of device monitored by a smart television content viewership data provider, for example. To address the inadvertent omission, a scale factor or multiplier may be applied to the content viewership data involving the missing devices. For example, the computing device may switch from one input source to another. As an example, when the computing device receives an indication that the user device has powered off, the computing device may switch from the feed from the user device to a panel-based reporting or ACR (e.g., ACR 238) from the audience measurement service provider or smart television content viewership data provider.

As an example, within a common home (e.g., multiple content receiving devices located in the same residential home), a scale factor of 1.4 may be applied when one device is missing, a scale factor of 1.7 may be applied when two devices are missing, a scale factor of 2 may be applied when three devices is missing, a scale factor of 2.4 may be applied when four devices are missing. To address the absence of data reported from a receiving device, the content viewership data may be modified or adjusted for conformance to a target distribution. The target distribution may be based on a national average of receiving devices (e.g., smart television devices) in a residential home, such as for the United States. The national average may be used to randomly assign a number of devices to compensate for missing receiving devices represented in the content viewership data for a particular residential home. Based on the randomly assigned number of device, an appropriate scaling factor may be applied in order to modify the deficient content viewing devices in view of the missing receiving devices, national average and/or target distribution.

For example, the content viewership data from the various input sources may be filtered into 250,000 common homes and 2.5 million homes. For example, for random assignment of devices based on the filtering and scaling, a scale factor of 0.27 for national homes and 0.26 for panel ratings may be applied for one device, a scale factor of 0.34 for national homes and 0.32 for panel ratings may be applied for two devices, a scale factor of 0.22 for national homes and 0.21 for panel ratings may be applied for three devices, and a scale factor of 0.17 for national homes and 0.20 for panel ratings may be applied for four devices. In this way, differences between the content viewership data from the smart television content viewership data provider and the content viewership data from the user device may be reconciled. The reconciliation may be performed with scale factors so that the missing content viewership data is modified based on the target distribution. For example, content viewing ratings from the smart television content viewership data provider may be scaled up, based on the national average, to account for missing devices. Such missing devices may be reflected in the content viewership data from the user device but not in the content viewership data from the smart television content viewership data provider.

At step 304, the computing device may categorize the content viewership data into content delivery categories. Example content delivery categories may include, for example, a terrestrial category, a wired category, satellite category, streaming category, and/or the like. The content viewership data for the terrestrial category may correspond to different habits than the content viewership data for the wired category. For example, terrestrial content delivery and wired delivery may generally correspond to different viewing patterns. For example, the length of content viewing sessions may be different for terrestrial versus wired. As another example, terrestrial networks may be available in more residential homes than wired networks because wired networks generally may require a subscription to access an offered wired service. The network type (e.g., terrestrial or wired) may correspond to a different scale parameter, a fit parameter, and an error parameter associated with a viewership statistic. For example, models for wired content viewing sessions may have different error and correlation parameters than those models for terrestrial content viewing sessions. At step 306, the computing device may perform a search for optimizing a threshold to which a viewing characteristic is compared. For example, the search may be a grid search to tune hyperparameters such that a time of day may be determined. The determine time of day may be a time for which determining or adjusting a corresponding threshold may yield the higher fit parameter and/or lowest error parameter. The viewing characteristic may correspond to a content viewing session indicated by the received content viewership data. For example, the viewing characteristic may correspond to a specific viewing statistic for a specific content item. The computing device may determine, based on a grid search, an hour of a plurality of hours to adjust a threshold corresponding to the hour. As an example, a combination of hyperparameters associated with the threshold may be determined.

The grid search may be used to develop models for each combination of hyperparameters and to determine an optimal combination of hyperparameters. For example, the grid search may be performed to determine an optimal hour to change a maximum session length parameter of the threshold. The maximum session length parameter may define the maximum length that a content viewing session may last before credit for the content viewing session is given, capped and/or edited. The precise hour of the plurality of hours may be determined via grid search to obtain more accurate adjustment of content viewership statistic adjustment. For example, the grid search may enable tuning of parameters such as hyperparameters. As an example, hyperparameters associated with the threshold may be tuned to a specific hour of a day or some other temporal level in order to obtain more accurate adjustment of content viewership statistics. For example, the grid search may be performed to determine that the most or optimal improvement to fit and error (e.g., fit and error parameters of the developed models) is achieved by reducing the threshold at hour 22 for the wired category. Hour 22 may refer to a content viewing session that begins at 10 pm local time or between 10 μm and 11 pm local time. The maximum session length parameter of the threshold may be adjusted based on a grid search. The adjustment to the maximum session length parameter may be iteratively performed based on a correlation parameter, an error parameter, and/or the like in order to improve the fit and reduce the error associated with the determined threshold. For example, a change to the maximum session length parameter may be iteratively determined based on correlation/fit and error, such as a root mean square error (RSME) parameter. As an example, a change to the maximum session length parameter and/or the threshold may be made in five minute increments. Changes to the maximum session length parameter may be iteratively made until no further improvement may be achieved.

At step 308, the computing device may determine a cap threshold. The computing device may use a capping algorithm determine the cap threshold and/or a false positive viewing event. As an example, a statistical percentile may be used to determine the threshold. A percentile cap may be determined based on at least one of: a percentile threshold, a network type, time zone, or a time of a day. For example, the percentile cap may comprise a threshold that varies by network type, time zone, or time of day. The accepted or credited duration of content viewing sessions may be capped according to a threshold of content viewing session durations within a 75^{th} to 95^{th} viewing percentile cap range, for example. That is, a content viewing session credited to an associated adjusted viewership statistic cannot last longer a length of a session falling within a 75^{th} to 95^{th} percentile of content viewing session lengths for the associated content item. The percentile cap range may depend by network and time of the day. The maximum content viewing session duration may be 6 hours while the minimum content viewing session duration may be 1.5 hours, for example. As an example, a time variant cap may be used to determine the threshold. That is, the time variant cap may change based on network type and which hour of a plurality of hours that the time variant cap corresponds to. The time variant cap may be determined based on at least one of: the network type, a time of a day, a minute of a day, or some other suitable time interval.

As an example, a classification of the user device may be used to determine the threshold. The classification of the user device may be determined based on at least one of: historical data associated with a likelihood of viewing the content item, an expected duration of a content viewing session associated with the content item, a time point of the content viewing session, or power data of the user device. The classification of the user device may be determined and adjusted based on an identity of the content item that the threshold is applied toward. The classification of the user device may include a reliable “good” type and an unreliable “bad” type. “Good” user devices may be determined via a machine learning algorithm that uses a quantity of long content viewing sessions as inputs for training the machine learning classifier. In this way, certain long content viewing sessions may be considered normal due to an association with reliable “good” user devices. Comparing a viewing characteristic to a threshold determined based on the classification of the user device may involve comparing abnormal tune lengths of content viewing session to expected tune lengths. For example, a content viewing session having an excessive duration would not be credited or reduced in credit to an associated adjusted viewership statistic if the excessive content viewing session was determined to correspond to a “bad” user device or if the excessive duration was determined to be an abnormal duration with reference to historical content viewing session durations for the associated content item.

At step 310, the computing device may determine a content rating. The content rating may be determined based on an adjustment to the viewership statistic. For example, a false positive viewing event may be determined and removed from the viewership statistic based on comparison of an associated viewing characteristic to the determined cap threshold. This comparison may be used to adjust a viewing statistic for a particular content item or a particular television channel. For example, a viewing statistic corresponding to a content viewing session spanning 8 pm to 6 am on the particular television channel may be adjusted or edited so that the viewing statistic reflects credit for a reduced content viewing session or does not reflect the content viewing session at all. For example, the adjusted viewing statistic may not include the content viewing session spanning 8:00 pm to 6:00 am or may instead include a cut off content viewing session spanning 8:00 pm to 10:00 pm based on a 120 minute threshold value as determined based on a capping algorithm for the particular content item or the particular television channel. The computing device may optimize a scale parameter, a fit parameter, and an error parameter associated with the adjusted viewership statistic. The optimization may be determined based on hour and/or network type. For example, the content rating may be generated based on the optimized scale parameter, a fit parameter, and an error parameter and the applied cap threshold. The generated content rating may more accurately reflect audience viewership for a particular content item as compared to the raw viewership statistic. The generated content rating may indicate a number of viewers and associated duration of content viewing session for the particular content item. At step 312, the computing device may determine an error parameter. For example, the error parameter may be determined with reference to panel-based reporting from audience measurement service provider or ratings from the smart television content viewership data provider. A coefficient, correlation, and error of the content rating may be compared to the panel-based reporting to assess the accuracy of the content rating.

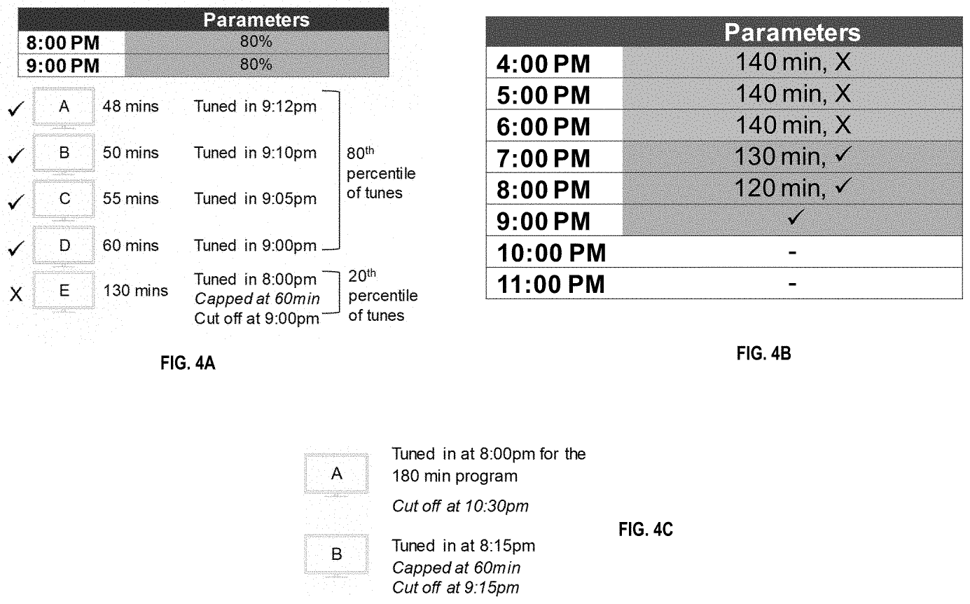

FIGS. 4A-4C show example viewership statistic data for determination of false positive viewing events. The capping algorithms may be implemented using the devices shown in FIGS. 1-3 such as the computing device 206. For example, a viewing characteristic of a content viewing session may be compared to a threshold based on a capping algorithm. As an example, a viewing characteristic may be a percentile rank of a viewing length of the content viewing session, time of viewing (e.g., an hour within a twenty four hour period), historic viewing length, historic performance or usage, and/or the like The comparison may be used to determine a false positive viewing event that is used when determining viewership data, such as removing the viewing event from viewership statistics and/or metrics. The comparison may be used to adjust the viewing statistic. FIG. 4A shows viewership statistic data based on a statistical percentile cap threshold according to an example capping algorithm. The capping algorithm may be a percentile capping algorithm, for example. As an example, a percentile parameter may be provided or determined for an hour of a plurality of hours (e.g., an hour of a 24 hour period) and used to determine a threshold for a specific content item. The threshold for the specific content may be applied to various content viewing sessions reported from and/or viewed on various user devices (e.g., user device 202). The percentile capping algorithm may involve using percentile of the statistical distribution, such as the 20^{th} percentile and the 80^{th} percentile to set the threshold. Durations (e.g., tune lengths) of content viewing sessions that exceed a longest duration within the 80^{th} percentile may be removed or excluded from a raw viewership statistic based on being content viewing sessions labeled as false positive viewing events.

For example, the percentile parameter may be 80% for 8:00 pm and 9:00 pm in a 24 hour period. 80% percent may refer to reducing or removing credit given to content viewing sessions whose duration value exceeds the duration value at the 80^{th} percentile. For example, for a set of five user devices watching a particular content item, the 80^{th} percentile comprises devices A, B, C, and D. The start time of the respective content viewing sessions for devices A, B, C, D started at 9:12 pm, 9:10 pm, 9:00 pm, and 9:00 pm. Because the particular content item ended at 10:00 pm, the longest tune or duration of a content viewing session in the 80^{th} percentile is 60 minutes. The 20^{th} percentile comprises device E, which may be considered an outlier. The start time of the respective content viewing sessions for device E started at 8:00 pm and ended at 10:10 pm. If the content viewing session for device E were included in a raw viewership statistic, this content viewing session would be credited for 130 minutes. This credit for this content viewing session viewing event may be inaccurate and considered a false positive viewing event because: the user device is powered on but the associated television is off, a viewer of device E starts watching a content item but stops watching without powering off the user device and/or the television, the viewer of device E forgets to turn off the user device so the user device is powered on for an excessive disproportionate quantity of time, an application or guide graphical element is overlaid onto the output or display of a television channel being received, and/or the like. As an example, an advertisement may play at 9:57 pm. An associated viewership statistic would not indicate that the viewer of device E actually viewed this advertisement because the corresponding content viewing session of device E is within the 20^{th} percentile and is capped at 60 minutes (9:00 pm), which is before the advertisement played.

The 80% percentile parameter may enable inaccurately reported viewing events and/or false positive viewing events to be capped, edited and/or removed from an adjusted viewership statistic. The content viewing session viewing event for Device E may be capped, cut off, or reduced to a duration of 60 minutes because 60 minutes is the longest tune duration within the 80^{th} percentile in this example. As such, this viewing event for Device E would only be credited for a 60 minute view in an associated viewership statistic for the corresponding viewed content item. The content viewing session viewing event for Device E may be removed entirely from the associated viewership statistic. In this way, outlier content viewing session such as those falling within the 20^{th} percentile may be capped and/or removed from the associated viewership statistic. The percentile parameter may differ between various hours of the 24 hour time period. For example, the percentile cap threshold may be 80% for 8:00 pm and 75% for 9:00 pm in a 24 hour period. For example, the percentile cap threshold may vary between the 75^{th} percentile and the 95^{th} percentile depending on network and a time of a day. The percentile cap threshold may be adjusted based on the content item programming available for the day and based on the various viewers during the day.

FIG. 4B shows a determination of a time variant cap threshold according to an example capping algorithm. The capping algorithm may be a time variant capping algorithm, for example. The determined threshold may comprise a number of thresholds set for each time period within a plurality of time periods. The number of thresholds may include a different threshold value set for each hour in a twenty four hour period in order to represent each hour of a day. As an example, a time variant maximum session length parameter may be provided or determined for each hour of a plurality of hours (e.g., an hour of a 24 hour period) and used to determine a threshold for a specific content item. For example, the time variant maximum session length parameter may be 140 minutes for 4:00 pm, 5:00 pm, and 6:00 pm; 130 minutes for 7:00 pm; and 120 minutes for 8:00 pm in a 24 hour period. The time variant maximum session length parameter for a particular time may specify the maximum duration that a content viewing session starting at or around that particular time. The particular time may be arranged by each hour in a 24 hour period. A maximum session length parameter for each hour of the day may be determined based on the precise hour and network type. For example, an advertisement may play at 9:00 pm. An associated viewership statistic may indicate or not indicate that various viewer actually viewed this advertisement depending on the start time and end time of their corresponding content viewing sessions.

Given the time variant maximum session length parameters for the times described above, all content viewing sessions tuning into the corresponding television channel or content item at a time between 7:00 pm and 9:00 pm would be included in the associated viewership statistic as long as the duration of these content viewing sessions did not exceed the applicable maximum session length parameter or threshold. As an example, a content viewing session that began at 7:00 pm and ended at 9:05 pm would be credited with viewing the advertisement as a viewing event included in the associated viewership statistic because the session duration of 125 minutes does not exceed the cap threshold of 130 minutes. Similarly, a session beginning at 9:00 pm and ending at a time that results in not exceeding the applicable time variant cap threshold would be counted as a viewing event. However, a session beginning at 6:00 pm and ending at 9:10 pm, for example, may be excluded from the associated viewership statistic and not counted as a viewing event because 190 minutes exceeds the maximum session length parameter for 6:00 pm of 140 minutes. Sessions that exceed a maximum length parameter may be excluded from the associated viewership statistic as a false positive viewing event. Sessions that exceed a maximum length parameter may be penalized by receiving reduced credit for a viewing event as reflected in the associated viewership statistic.

Each content viewing session for a particular content item may be capped to an optimized threshold by determining an optimal maximum session length parameter. As an example, maximum session length parameters for later times in the day may be shorter than those for earlier times in the day (e.g., prime time). The maximum session length parameter for 10:00 pm may be 60 minutes while the maximum session length at 6:00 pm may be 120 minutes, for example. The maximum session length parameter may be time variant depending on the time of day. An improved, ideal, or optimized maximum session length parameter for a specific time of day may be determined in an iterative process, such as an iterative process including a grid search. The respective content viewing sessions for all viewers of a content item may be treated similarly with respect to an adjusted viewership statistic. For example, the maximum session length parameter may be the same for all viewers of the content item regardless of historical data. Instead, the maximum session length parameter may vary merely depending on the time that a viewer's content viewing session begins. A grid search may be performed, as described above, to determine an hour of the 24 hour period to adjust the maximum session length parameter corresponding to the hour. The adjusted maximum session length parameter may be improved or optimized based on input data (e.g., as recited in step 302). As an example, a combination of hyperparameters associated with the threshold may be determined. The grid search may be used to develop models for each combination of hyperparameters and to determine an optimal combination of hyperparameters.

For example, the grid search may be performed to determine an optimal hour to change a maximum session length parameter of the threshold. For example, the grid search may be performed to enumerate various combinations of time variant thresholds and maximum session length parameters. The enumeration may be iterative. As an example, an iterative optimization process may be performed to determine the most accurate combination of time variant cap threshold for each threshold for the 24 hour period. The determination of each time variant cap threshold may involve a selection of discrete threshold cap values such as 30, 90, and 120 minute thresholds. The determined threshold values may be continuous. In this way, different thresholds may be applied at different hours and the determination of time variant cap thresholds may be iteratively improved. For example, the cap threshold for 7:00 am may be 30 minutes while the cap threshold for 8:00 am may be 60 minutes. Time variant cap thresholds may be applied at different time intervals than each hour. For example, a time variant cap threshold may be determined for every 30 minutes in a 12 hour period.

FIG. 4C shows a determination of a user device classification threshold according to an example capping algorithm. The capping algorithm may be a device classification algorithm, for example. The device classification algorithm may involve determining a device or software classification algorithm. As an example, a group of devices or software (e.g., software application that may be executed on a mobile device) may be classified. For example, the group of devices may include user devices, televisions, mobile devices, smartphones, tablets, computers, and/or the like. As an example, a group of devices such as user device A and user device B (e.g., each may be a user device 202) may be classified and used to determine a threshold for a specific content item. The devices may be set top boxes, for example. The devices may be classified into a “good” category and a “bad” category. The allocation of devices between the “good” category and the “bad” category may be based on historic behavior of the devices, such as historical power usage data indicating historical statistical information of respective durations of previous content viewing sessions. A “good” or reliable device such as user device A may historically have durations of previous content viewing sessions that are consistent with normal average durations while a “bad” or unreliable device such as user device B may historically have a disproportionate number of abnormal durations of previous content viewing sessions.

The historic behavior may be indicative of whether the corresponding user device is reliable or unreliable, for example. Reliability may be assessed based on the number of abnormal tune lengths of content viewing session associated with a particular user device. The “good” category may correspond to user devices that historically have a high proportion of content viewing sessions of acceptable duration. The “bad” category may correspond to user devices that historically have a disproportionate quantity of content viewing sessions of questionable duration (e.g., a content viewing session duration of 10 hours from late night to early morning that suggests a user device was left powered on overnight). For example, power usage data of the user device may be used to identify “ghost” tunes such as associated content viewing session of abnormal length in which no viewer is watching the associated television.

As an example, a content viewing session of abnormal duration may involve a user device tuning into a “Super Bowl” football championship game for 10 hours, which far exceeds the duration of the football game. The classification of the user devices may be used to determine how much credit should be given for the abnormally long “Super Bowl” content viewing session in an associated viewership statistic for the corresponding content item (e.g., NBC television channel). In general, more credit should be given to reliable “good” user devices as compared to unreliable “bad” user devices. As an example, an advertisement may play at 9:30 pm. The advertisement may be displayed on or output to televisions during a content item that is a content program starting at 8:00 pm with a duration of 180 minutes, for example. The user device classification threshold may be determined based on the average length of content viewing session for the 180 minute content program by user devices classified within the “good” category. “Good” user devices may receive credit in an associated viewership statistic corresponding the content program. For example, the “good” user devices may be credited with a viewing event lasting up to 2.5 times the average length of content viewing sessions by user devices classified within the “good” category.

As an example, for the advertisement playing at 9:30 pm, a viewing event for the advertisement may be credited for a “good” user device even though the “good” user device may be tuned to the 180 minute content program or corresponding television channel for 240 minutes until 12:00 am. Because a viewing characteristic of this 240 minute content session such as a historical reliability of the associated user device is determined and compared favorably to a threshold, the 240 minute session may be capped at 10:30 pm or reduced in credit to a 150 minute session duration. This user device classification threshold may be applied by crediting “good” user device with viewing events (e.g., advertisement impressions) up to 2.5 times an average content session duration. For example, the average content session duration may be 60 minutes, which yields a user device classification threshold of 150 minutes. In contrast, a “bad” user device may be capped or reduced in credit to the length of an average content session. As an example, a “bad” user device that started a content viewing session at 8:15 pm and ended at 12:00 am may be capped at the average content session duration of 60 minutes. Accordingly, the capped content viewing session for the “bad” user device would be cut off at 9:15 pm and receive only 60 minutes of credit for an associated viewing event in a corresponding viewership statistic for the 180 minute content program or the advertisement at 9:30 μm. The content viewing session spanning 8:15 pm and ending at 12:00 am may also be labeled as a false positive viewing event and removed from the corresponding viewership statistic altogether.

The user device classification threshold may be determined based on historical data associated with a likelihood of viewing a content item, an expected duration of a content viewing session associated with the content item, a time point of the content viewing session, power data of a user device, and/or the like. For example, the power data may indicate what content items that the corresponding user device typically tunes into so that a “good” or “bad” classification may be determined. The viewing characteristic may include a percentile rank of a viewing length of the content viewing session, an hour within the twenty four hour period, historic viewing length data, and/or the like. The viewing characteristic may be compared to the user device classification threshold to determine false positive viewing events, which may be reduced in credit or removed from the corresponding viewership statistic. Adjusting the viewership statistic via a capping algorithm may enable more accurate of advertisers for actual views of their advertisements, for example.

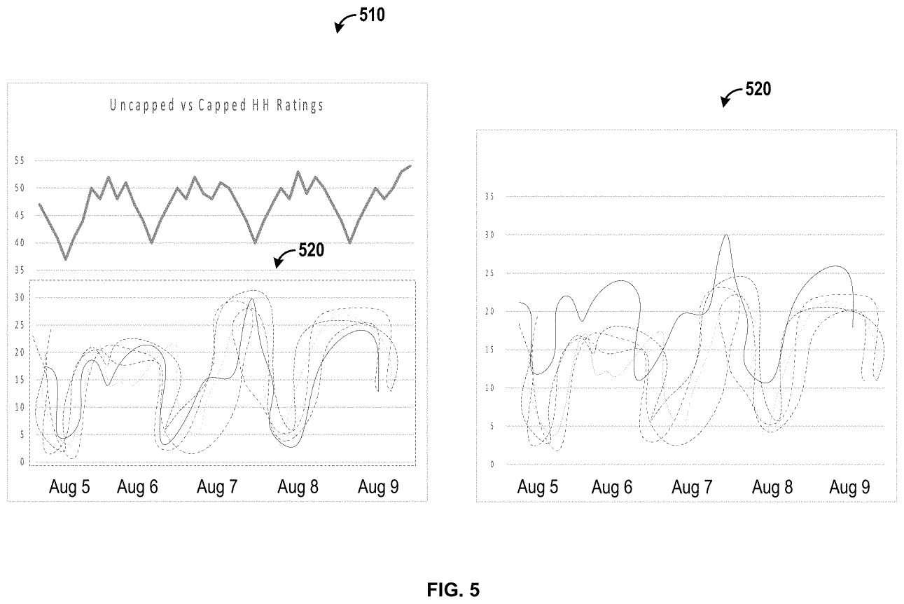

FIG. 5 shows example graphs 510, 520 that may validate the effectiveness of various capping algorithms. The graphs 510, 520 indicate a value of a content rating (e.g., such as that determined in step 310) on their respective y-axis. The y-axis may range from 0 to 55 for graph 510 and range from 0 to 26 for graph 520. The x-axis for each graph of the graphs 510, 520 indicates a time interval, such as the week of August 5 to August 9, in which a content rating is generated continuously for the week and each day in the time interval is indicated on the respective x-axis. The graph 510 indicates that gross content ratings or raw viewership statistics range from a low value of approximately 37 to a high value of approximately 54. The gross content ratings or raw viewership statistics may represent uncapped ratings for or per household. As another example, such uncapped ratings may be calculated for a subset of people, such as women aged between 18-34. The graph 510 may exhibit a pattern or seasonality throughout a day. For example, the gross content ratings or raw viewership statistics are typically high during evening prime time.

The graph 520 similarly may exhibit a pattern or seasonality throughout a day, such as gross content ratings or raw viewership statistics indicating relatively high viewership during the day and even higher viewership during the evening prime time. The graph 520 may indicate the respective values of adjusted content ratings or viewership statistics that maybe adjusted according to the capping algorithms described herein as well as based on ratings calculated by an audience measurement service provider (e.g., panel-based reporting) or smart television content viewership data provider (e.g., ACR such as ACR data 238). For example, the graph 520 may indicate capped ratings derived from applying capping algorithms described herein to the data of graph 510. The graph 520 indicates that adjusted content ratings or viewership statistics range from a low value of approximately 3 to a high value of approximately 26. This may illustrate the advantageous removal or reduction in credit of false positive viewing events from the corresponding of adjusted content ratings or viewership statistic. That is, the capped content ratings or viewership statistics as shown in graph 520 may more accurately reflect actual viewership of various content items than the uncapped ratings depicted in graph 510. The lines in graph 520 may correspond to adjustments made to input data from the audience measurement service provider or the smart television content viewership data provider and also correspond to adjustments made based on a statistical percentile cap threshold, a time variant cap threshold, or a set top box classification threshold, for example.

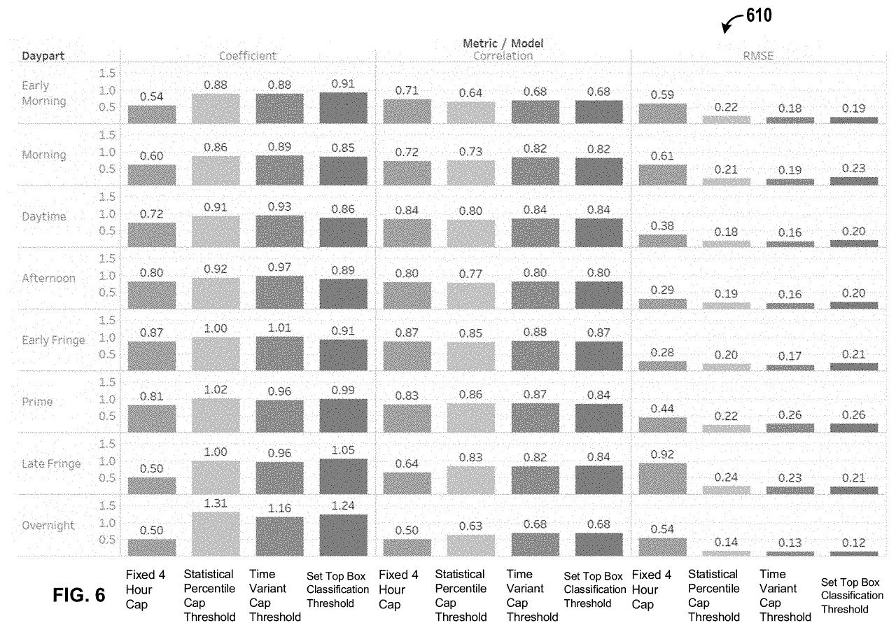

FIG. 6 shows an example graph 610 that indicates a coefficient, correlation, and error of an adjusted viewership statistic (e.g., metric or model) that is adjusted according to various capping algorithms. As shown in the x-axis of graph 610, the coefficient, correlation, and error values are arranged according to a fixed 4 hour cap, a statistical percentile cap threshold (P1), a time variant cap threshold (P2), or a set top box classification threshold (P3), for example. As shown in the x-axis of graph 610, the coefficient, correlation, and error values are also arranged according a portion of a day (e.g., 24 hour period), including early morning, morning, daytime, afternoon, early fringe, prime, late fringe, and overnight, for example. As an example, the values of the coefficient, correlation, and error values may range from 0.5 to 1.5. The coefficient value may be measured based on coefficient parameter indicative of a comparison between an adjusted viewership statistic and a content rating determined from panel-based reporting, the correlation value may be measured based on an correlation parameter indicative of how two time variables are linearly related from a grid search optimization process, the error value may be measured as a root mean square error (RSME) parameter, for example. As illustrated by the respective values of the coefficient parameter, correlation parameter, and RSME parameter, adjusted viewership statistic provide more accurate viewership statistics that better reflect actual viewership of content items (e.g., advertisements). In particular, the coefficient parameter for capping algorithms based on statistical percentile cap threshold (P1), a time variant cap threshold (P2), or a set top box classification threshold (P3) are higher than the coefficient parameter for the fixed 4 hour cap. The correlation parameter and RSME parameter for capping algorithms based on statistical percentile cap threshold (P1), a time variant cap threshold (P2), or a set top box classification threshold (P3) are higher than the correlation parameter and RSME parameter for the fixed 4 hour cap.

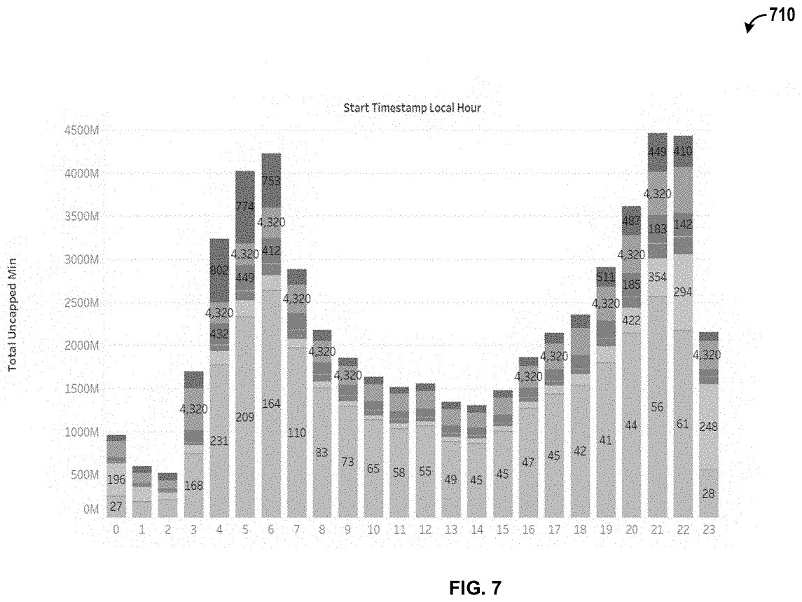

FIG. 7 shows an example graph 1110 that indicates instances of uncapped viewership. Instances of uncapped viewership may refer to content viewing sessions that involve periods of receiving content items that are not being actively viewed by a viewer. That is, the viewer may stop or not be watching a television even though the television and/or associated set top box is still receiving content. As an example, the graph 1110 may indicate an average session length of the content viewing sessions. For example, the instances of uncapped viewership may be reflected by session termination codes indicative of how a content viewing session was terminated. The session termination codes may be part of input data (e.g., content viewing input data received in step 302) or included, generated, or stored as data source information (e.g., viewer data 232 or set top box data 236 stored at the data source device 204. As an example, the session termination codes may include an app launch code, a capped code, a screen saver on code, a on standby event, a on standby overlay timeout, a reboot overlay timeout, a standby, a keypress code, and/or the like. For example, the session termination codes may be categorized by “organic,” “non-organic,” or “mixed” in which “organic” may refer to a termination triggered by a user action while “non-organic” may refer to a termination triggered without a user action and “mixed” refers to a combination of “organic” and “non-organic.”

The app launch session termination code may indicate a content viewing session that was considered ended by an application or guide graphical element being overlaid or launched onto the output or display of the associated television display. The capped termination code may indicate a content viewing session that was considered ended based on an abnormally long content viewing session such as 10 hours, for example. As another example, the capped code may indicate that a corresponding content viewing session was very long such that the length or duration of the corresponding content viewing session was considered excessively long even prior to any capping. That is, the duration of the corresponding content viewing session may have already been considered an excessive or abnormal quantity of time before application of any capping algorithm. The screen saver on code may indicate a content viewing session that was considered ended based on a screen saver appearing on the output or display of the associated television display. The on standby event code may indicate a content viewing session that was considered ended based on the associated set top box being powered off, entering a standby mode, or entering a power save mode. As an example, the associated set top box may be turned off by a user. The on standby overlay timeout code may indicate a content viewing session that was considered ended based on the timeout period causing an overlay timeout such as the associated television displaying a overlaid screensaver after 4 hours of no activity (e.g., user activity). The reboot overlay timeout code may indicate a content viewing session that was considered ended based on no response is received from a user prompt. As an example, no response may be received from a daily update prompt.

The standby code may indicate a content viewing session that was considered ended based on the associated television and/or set top box being powered off. As an example, a user may select a “power down now” option from a remote control corresponding to the associated television and/or set top box. As an example, the standby code may comprise an overlay timeout caused by 5 hours of no activity (e.g., exceeding a 5 hour timeout period) resulting in a transition to a “nap mode.” As an example, the standby code may comprise an overlay timeout caused by 5 hours of no activity (e.g., exceeding a 5 hour timeout period) resulting in a transition to a “silent nap mode.” The keypress code may indicate a content viewing session that was considered ended based on a user pressing a button of a television remote to turn off an associated television after a content item being viewed during the content viewing session ends. The keypress code may indicate a content viewing session that was considered ended based on an High-Definition Multimedia Interface (HDMI) indicator being in an off state. The “organic” category may include the app launch code and keypress code. The “non-organic” category may include the capped code and the screen saver on code. The “mixed” category may include the on standby event code, the on standby overlay timeout code, the reboot overlay timeout code, and the standby code.

The x-axis of the graph 1110 may indicate an index of 24 time periods (starting at 0) such as each hour of a 24 hour day. The y-axis of the graph 1110 may indicate a total number of uncapped minutes for all content viewing session beginning at the corresponding hour (e.g., having a start time stamp within the corresponding hour). The total number of uncapped minutes may be organized according to various content items. Each hour of the twenty hour period has a graphical hour indicating the number of instances of the termination time codes as well as the instances of tune events. The instances of the tune events may involve a set top box and/or television being powered on and/or receiving content from a content provider without a termination event. That is, the tune events may be viewing events involving false positive viewing events reflecting content viewing sessions of having abnormal durations without termination events. The graph 1110 may indicate that many content viewing sessions in the morning (e.g., time period 4) may have a relatively high number of sessions having abnormal durations without termination events. The graph 1110 may indicate that many content viewing sessions in the evening are ended or cut off by a reboot event, such as based on no response is received from a user prompt.

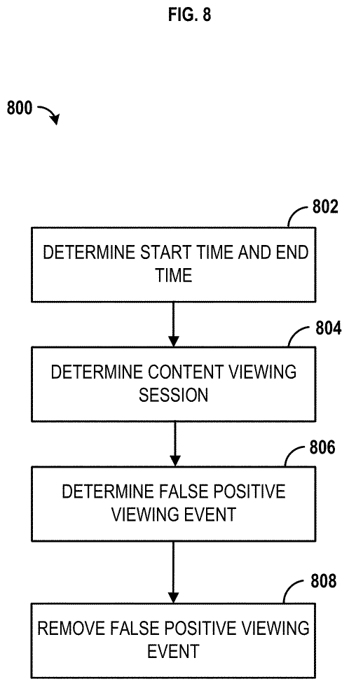

FIG. 8 shows a flowchart illustrating an example method 800 for content viewership statistic adjustment. The method 800 may be implemented using the devices shown in FIGS. 1-2. For example, the method 800 may be implemented using a device such as the computing device 206. At step 802, a computing device may determine a start time and an end time associated with a content item. For example, the computing device may determine a start time of a delivery of a content item and an end time of the delivery of the content item. For example, the computing device may determine the start time and the end time based on determining an existence of a false positive viewing event. The determination of the start time and the end time may be based on content viewership data. For example, the start time and the end time of delivery of the content item may be represented or indicated in content metadata. The content metadata may be received from a user device (e.g., the user device 202) or be included in a raw viewership statistic. The start time and the end time may be received or generated by a device, such as the user device 202, the computing device 206, the data source device 204. The start time and the end time may be stored in a database such as the database 220. The computing device may receive the content viewership data. The content viewership data may comprises at least one of: data from a data management platform (e.g., audience measurement service provider or smart television content viewership data provider) or an ACR feed (e.g, ACR data 238). At step 804, the computing device may determine a content viewing session. The determination of the content viewing session may be based on the start time and the end time. For example, the content viewing session may be associated with one or more viewers watching a portion of or the entirety of the content item delivered between the start time and the end time. The content viewing session may be associated with a reporting device (e.g., set top box, television, tablet, smartphone, etc.) on which a delivered content item may be received and/or viewed.

At step 806, the computing device may determine a false positive viewing event. The determination of the false positive event may be based on comparing a viewing characteristic of the content viewing session to a threshold, such as a content output threshold. The threshold may be a cap threshold, a percentile cap threshold, a time variant threshold, a device threshold, and/or the like, for example. The viewing characteristic may be a percentile rank of a viewing length of the content viewing session, an hour within a twenty four hour period, or historic viewing length data, and/or the like. The false positive viewing event may be determined based on a suitable capping algorithm disclosed herein. The false positive viewing event may be indicative of the content item being output and not viewed during the content viewing session. As an example, the content output threshold or a maximum session length parameter of the content output threshold may be determined based on a capping algorithm. As an example, the false positive viewing event may be a content viewing session having an abnormal duration that implies no viewer watched an associated content item for the full duration of the content viewing session (e.g., a viewer started watching a movie content item but stopped watching and neglected to power off their set top box and/or television). The content output threshold may be determined for an hour of a plurality of hours (e.g., a 24 hour period). The content output threshold may comprise at least one of: a cap threshold that defines a maximum duration of a content viewing session, a percentile cap that defines a maximum percentile of a duration of the content viewing session, a time variant cap that defines the maximum duration of the content viewing session for the hour, or a set top box classification.

The computing device may determine the percentile cap of the content output threshold based on at least one of a network type or a time of a day. The computing device may determine the time variant cap of the content output threshold based on at least one of: the network type, a time of a day, or a minute of a day. The computing device may determine the set top box classification of the content output threshold based on at least one of: historical data associated with a likelihood of viewing the content item, an expected duration of a content viewing session associated with the content item, a time point of the content viewing session, or power data of the set top box. For example, the set top box classification may comprise a reliable classification or an unreliable classification. As an example, determination of the false positive event may comprise the computing device iteratively determining, based on at least one of: a correlation parameter, an error parameter, or a root mean square error (RSME) parameter, the maximum session length parameter of the content output threshold. At step 808, the computing device may remove a false positive viewing event from a viewership statistic. For example, the viewership statistic may be adjusted by removing credit given for a viewing event determined to be a false positive viewing event. For example, the viewership statistic may be adjusted by reducing credit for the false positive viewing event. The computing device may determine, based on a network type, at least one of: a scale parameter, a fit parameter, and an error parameter associated with the viewership statistic.

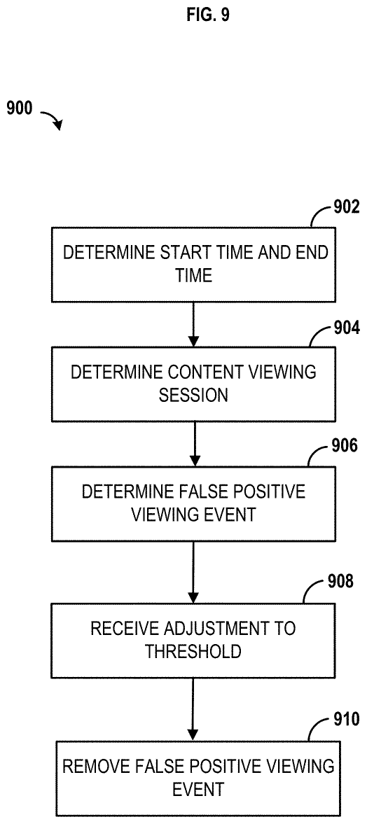

FIG. 9 shows a flowchart illustrating an example method 900 for content viewership statistic adjustment. The method 900 may be implemented using the devices shown in FIGS. 1-2. For example, the method 900 may be implemented using a device such as the computing device 206. At step 902, a computing device may determine a start time and an end time associated with a content item. For example, the computing device may determine a start time of a delivery of a content item and an end time of the delivery of the content item. For example, the computing device may determine the start time and the end time based on determining an existence of a false positive viewing event. The determination of the start time and the end time may be based on content viewership data. For example, the start time and the end time of delivery of the content item may be represented or indicated in content metadata. The content metadata may be received from a user device (e.g., the user device 202) or be included in a raw viewership statistic. The start time and the end time may be received or generated by a device, such as the user device 202, the computing device 206, the data source device 204. The start time and the end time may be stored in a database such as the database 220. The computing device may receive the content viewership data. The content viewership data may comprises at least one of: data from a data management platform (e.g., audience measurement service provider or smart television content viewership data provider) or an ACR feed (e.g., ACR data 238). At step 904, the computing device may determine a content viewing session. The determination of the content viewing session may be based on the start time and the end time. For example, the content viewing session may be associated with one or more viewers watching a portion of or the entirety of the content item delivered between the start time and the end time. The content viewing session may be associated with a reporting device (e.g., set top box, television, tablet, smartphone, etc.) on which a delivered content item may be received and/or viewed.

At step 906, the computing device may determine a false positive viewing event. The determination of the false positive event may be based on a viewing characteristic of the content viewing session and a grid search associated with a threshold such as a content output threshold for an hour of a plurality of hours. The threshold may be a cap threshold, a percentile cap threshold, a time variant threshold, a device threshold, and/or the like, for example. The viewing characteristic may be a percentile rank of a viewing length of the content viewing session, an hour within a twenty four hour period, or historic viewing length data, and/or the like. The maximum session length parameter of the content output threshold may be adjusted based on the grid search. The precise hour of the plurality of hours may be determined via grid search to obtain more accurate adjustment of content viewership statistic adjustment. For example, the grid search may be performed to determine that the most or optimal improvement to fit and error (e.g., fit and error parameters of the developed models) is achieved by reducing the content output threshold at hour 22 for the cable category. The false positive viewing event may be determined based on a suitable capping algorithm disclosed herein. As an example, the content output threshold or a maximum session length parameter of the content output threshold may be determined based on a capping algorithm. As an example, the false positive viewing event may be a content viewing session having an abnormal duration that implies no viewer watched an associated content item for the full duration of the content viewing session (e.g., a viewer started watching a movie content item but stopped watching and neglected to power off their set top box and/or television). The content output threshold may be determined for an hour of a plurality of hours (e.g., a 24 hour period). The content output threshold may comprise at least one of: a cap threshold that defines a maximum duration of a content viewing session, a percentile cap that defines a maximum percentile of a duration of the content viewing session, a time variant cap that defines the maximum duration of the content viewing session for the hour, or a set top box classification.

The computing device may determine the percentile cap of the content output threshold based on at least one of a network type or a time of a day. The computing device may determine the time variant cap of the content output threshold based on at least one of: the network type, a time of a day, or a minute of a day. The computing device may determine the set top box classification of the content output threshold based on at least one of: historical data associated with a likelihood of viewing the content item, an expected duration of a content viewing session associated with the content item, a time point of the content viewing session, or power data of the set top box. For example, the set top box classification may comprise a reliable classification or an unreliable classification. As an example, determination of the false positive event may comprise the computing device iteratively determining, based on at least one of: a correlation parameter, an error parameter, or a root mean square error (RSME) parameter, the maximum session length parameter of the content output threshold.

At step 908, the computing device may receive an adjustment to the content output threshold for the hour. The receipt of the adjustment to the content output threshold may be based on the grid search. For example, the grid search may be performed for adjustment of the content output threshold to improve fit and error is achieved by reducing the content output threshold at hour 22 (the hour of the plurality of hours). Hour 22 may refer to a content viewing session that begins at 10 pm local time or between 10 pm and 11 pm local time. For example, a change to the maximum session length parameter of the content output threshold for hour 22 may be iteratively determined based on correlation/fit and error, such as a root mean square error (RSME) parameter. As an example, a change to the maximum session length parameter and/or the content output threshold may be made in five minute increments. Changes to the maximum session length parameter may be iteratively made until no further improvement may be achieved. At step 910, the computing device may remove a false positive viewing event from a viewership statistic. The removal of the false positive event may be based the adjustment to the content output threshold. The false positive viewing event may be indicative of the content item being output and not viewed during the content viewing session. The removal of the false positive event may comprise adjusting the viewership statistic. For example, the viewership statistic may be adjusted by removing credit given for a viewing event determined to be a false positive viewing event. For example, the viewership statistic may be adjusted by reducing credit for the false positive viewing event. The computing device may determine, based on a network type, at least one of: a scale parameter, a fit parameter, and an error parameter associated with the viewership statistic.

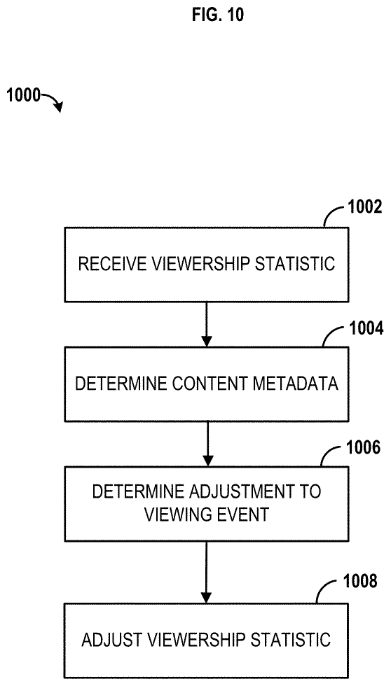

FIG. 10 shows a flowchart illustrating an example method 1000 for content viewership statistic adjustment. The method 1000 may be implemented using the devices shown in FIGS. 1-2. For example, the method 1000 may be implemented using a device such as the computing device 206. At step 1002, a computing device may receive a viewership statistic. For example, the viewing characteristic may be a percentile rank of a viewing length of the content viewing session, an hour within a twenty four hour period, or historic viewing length data, and/or the like. At step 1004, the computing device may determine content metadata. As an example, the content metadata may be associated with sending a content item for a content viewing session. For example, the content metadata may comprise a start time of a delivery of a content item and an end time of the delivery of the content item. The computing device may determine the start time and the end time based on determining an existence of a false positive viewing event. The false positive viewing event may be indicative of the content item being output and not viewed during the content viewing session. The computing device may receive content viewership data. The computing device may determine the start time and the end time based on content viewership data. For example, the start time and the end time of delivery of the content item may be represented or indicated in content metadata. The content metadata may be received from a user device (e.g., the user device 202) or be included in a raw viewership statistic. The start time and the end time may be received or generated by a device, such as the user device 202, the computing device 206, the data source device 204. The start time and the end time may be stored in a database such as the database 220. The content viewership data may comprises at least one of: data from a data management platform (e.g., audience measurement service provider or smart television content viewership data provider) or an ACR feed (e.g, ACR data 238).

At step 1006, the computing device may determine an adjustment to a viewing event. For example, the determination of the adjustment to the viewing event may be based on comparing the viewing characteristic of the content viewing session to a threshold such as a content output threshold. The threshold may be a cap threshold, a percentile cap threshold, a time variant threshold, a device threshold, and/or the like, for example. The computing device may determine the content output threshold for an hour of a plurality of hours (e.g., 24 hour period). The content output threshold may comprise at least one of: a cap threshold that defines a maximum duration of a content viewing session, a percentile cap that defines a maximum percentile of a duration of the content viewing session, a time variant cap that defines the maximum duration of the content viewing session for the hour, or a set top box classification. The computing device may determine the percentile cap of the content output threshold based on at least one of a network type or a time of a day. The computing device may determine the time variant cap of the content output threshold based on at least one of: the network type, a time of a day, or a minute of a day. The computing device may determine the set top box classification of the content output threshold based on at least one of: historical data associated with a likelihood of viewing the content item, an expected duration of a content viewing session associated with the content item, a time point of the content viewing session, or power data of the set top box. For example, the set top box classification may comprise a reliable classification or an unreliable classification.

As an example, determination of the adjustment to the viewing event may comprise the computing device iteratively determining, based on at least one of: a correlation parameter, an error parameter, or a root mean square error (RSME) parameter, the maximum session length parameter of the content output threshold. At step 1008, the computing device may adjust the viewership statistic. For example, the adjustment of the viewership statistic may comprise removing a false positive event from the viewership statistic. For example, the adjustment of the viewership statistic may comprise removing credit given for a viewing event determined to be a false positive viewing event. As an example, the viewership statistic may be adjusted by reducing credit for the false positive viewing event. The computing device may determine, based on a network type, at least one of: a scale parameter, a fit parameter, and an error parameter associated with the viewership statistic.

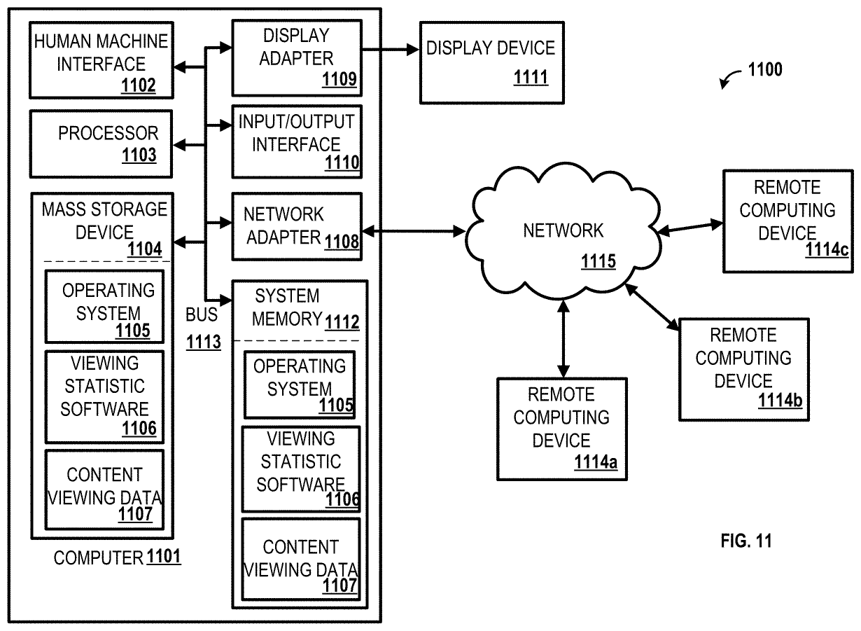

The methods and systems may be implemented on a computer 1101 as illustrated in FIG. 11 and described below. Similarly, the methods and systems disclosed may utilize one or more computers to perform one or more functions in one or more locations. FIG. 11 shows a block diagram illustrating an exemplary operating environment 1100 for performing the disclosed methods. This exemplary operating environment 1100 is only an example of an operating environment and is not intended to suggest any limitation as to the scope of use or functionality of operating environment architecture. Neither should the operating environment 1100 be interpreted as having any dependency or requirement relating to any one or combination of components illustrated in the exemplary operating environment 1100.

The present methods and systems may be operational with numerous other general purpose or special purpose computing system environments or configurations. Examples of well-known computing systems, environments, and/or configurations that may be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems may be performed by software components. The disclosed systems and methods may be described in the general context of computer-executable instructions, such as program modules, being executed by one or more computers or other devices. Generally, program modules comprise computer code, routines, programs, objects, components, data structures, and/or the like that perform particular tasks or implement particular abstract data types. The disclosed methods may also be practiced in grid-based and distributed computing environments where tasks are performed by remote processing devices that are linked through a communications network. In a distributed computing environment, program modules may be located in local and/or remote computer storage media including memory storage devices.

The user device 202, the data source device 204, and/or the computing device 206 of FIGS. 1-2 may be or include a computer 1101 as shown in the block diagram 1100 of FIG. 11. The computer 1101 may include one or more processors 1103, a system memory 1112, and a bus 1113 that couples various system components including the one or more processors 1103 to the system memory 1112. In the case of multiple processors 1103, the computer 1101 may utilize parallel computing. The bus 1113 is one or more of several possible types of bus structures, including a memory bus or memory controller, a peripheral bus, an accelerated graphics port, or local bus using any of a variety of bus architectures.

The computer 1101 may operate on and/or include a variety of computer readable media (e.g., non-transitory). The readable media may be any available media that is accessible by the computer 1101 and may include both volatile and non-volatile media, removable and non-removable media. The system memory 1112 has computer readable media in the form of volatile memory, such as random access memory (RAM), and/or non-volatile memory, such as read only memory (ROM). The system memory 1112 may store data such as the content viewership data 1107 and/or program modules such as the operating system 1105 and the viewing statistic software 1106 that are accessible to and/or are operated on by the one or more processors 1103.

The computer 1101 may also have other removable/non-removable, volatile/non-volatile computer storage media. FIG. 11 shows the mass storage device 1104 which may provide non-volatile storage of computer code, computer readable instructions, data structures, program modules, and other data for the computer 1101. The mass storage device 1104 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and/or the like.

Any quantity of program modules may be stored on the mass storage device 1104, such as the operating system 1105 and the viewing statistic software 1106. Each of the operating system 1105 and the viewing statistic software 1106 (or some combination thereof) may include elements of the program modules and the viewing statistic software 1106. The viewing statistic software 1106 may include processor executable instructions that cause determining, storing, receiving, and/or the like of a viewership statistic (e.g., a raw viewership statistic). The viewership statistic may be indicative of a quantity of viewers for a particular content item, content program, time interval, content channel, television channel, and/or the like. The viewing statistic software 1106 may include processor executable instructions that cause adjustment of the viewership statistic, such as removal of a determined false positive event from the viewership statistic or removal or reduction of credit of a content viewing session associated with the viewership statistic. The content viewership data 1107 may also be stored on the mass storage device 1104. The content viewership data 1107 may comprise at least one of: data from a data management platform or an ACR feed (e.g., comprising ACR data 238). The content viewership data 1107 may comprise metadata indicative of a start time of a delivery of a content item and an end time of the delivery of the content item. The content viewership data 1107 may be stored in any of one or more databases (e.g., database 220) known in the art. Such databases may be DB2®, Microsoft® Access, Microsoft® SQL Server, Oracle®, MySQL, PostgreSQL, and the like. The databases may be centralized or distributed across locations within the network 1115.

A user may enter commands and information into the computer 1101 via an input device (not shown). Examples of such input devices include, but are not limited to, a keyboard, pointing device (e.g., a computer mouse, remote control), a microphone, a joystick, a scanner, tactile input devices such as gloves, and other body coverings, motion sensor, and the like. These and other input devices may be connected to the one or more processors 1103 via a human machine interface 1102 that is coupled to the bus 1113, but may be connected by other interface and bus structures, such as a parallel port, game port, an IEEE 1394 Port (also known as a Firewire port), a serial port, network adapter 1108, and/or a universal serial bus (USB).

The display device 1111 may also be connected to the bus 1113 via an interface, such as the display adapter 1109. It is contemplated that the computer 1101 may include more than one display adapter 1109 and the computer 1101 may include more than one display device 1111. The display device 1111 may be a monitor, an LCD (Liquid Crystal Display), light emitting diode (LED) display, television, smart lens, smart glass, and/or a projector. In addition to the display device 1111, other output peripheral devices may be components such as speakers (not shown) and a printer (not shown) which may be connected to the computer 1101 via the Input/Output Interface 1110. Any step and/or result of the methods may be output (or caused to be output) in any form to an output device. Such output may be any form of visual representation, including, but not limited to, textual, graphical, animation, audio, tactile, and the like. The display device 1111 and computer 1101 may be part of one device, or separate devices.

The computer 1101 may operate in a networked environment using logical connections to one or more remote computing devices 1114a, 1114b, 1114c. A remote computing device may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device, and so on. Logical connections between the computer 1101 and a remote computing device 1114a, 1114b, 1114c may be made via a network 1115, such as a local area network (LAN) and/or a general wide area network (WAN). Such network connections may be through the network adapter 1108. The network adapter 1108 may be implemented in both wired and wireless environments. Such networking environments are conventional and commonplace in dwellings, offices, enterprise-wide computer networks, intranets, and the Internet.

Application programs and other executable program components such as the operating system 1105 are shown herein as discrete blocks, although it is recognized that such programs and components reside at various times in different storage components of the computing device 1101, and are executed by the one or more processors 1103 of the computer. An implementation of the viewing statistic software 1106 may be stored on or sent across some form of computer readable media. Any of the described methods may be performed by processor-executable instructions embodied on computer readable media.

For purposes of illustration, application programs and other executable program components such as the operating system 1105 are illustrated herein as discrete blocks, although it is recognized that such programs and components may reside at various times in different storage components of the computing device 1101, and are executed by the one or more processors 1103 of the computer 1101. An implementation of viewing statistic software 1106 may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” may comprise volatile and non-volatile, removable and non-removable media implemented in any methods or technology for storage of information such as computer readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

While the methods and systems have been described in connection with specific examples, it is not intended that the scope be limited to the particular embodiments set forth, as the embodiments herein are intended in all respects to be illustrative rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations may be made without departing from the scope or spirit. Other embodiments will be apparent to those skilled in the art from consideration of the specification and practice described herein. It is intended that the specification and examples be considered as exemplary only, with a true scope and spirit being indicated by the following claims.

What is claimed is:

1. A method comprising:
determining, based on content viewership data, a start time of a delivery of a content item and an end time of the delivery of the content item;
determining, based on the start time and the end time, a content viewing session;
determining, based on comparing a viewing characteristic of the content viewing session to a content output threshold, a false positive viewing event, wherein the false positive viewing event is indicative of the content item being output and not viewed during the content viewing session; and
removing the false positive viewing event from a viewership statistic.

2. The method of claim 1, further comprising receiving the content viewership data, wherein the content viewership data comprises at least one of: data from a data management platform or an Automatic Content Recognition (ACR) feed.

3. The method of claim 1, further comprising determining the content output threshold for an hour of a plurality of hours, wherein the content output threshold comprises at least one of: a cap threshold that defines a maximum duration of a context viewing session, a percentile cap that defines a maximum percentile of a duration of the content viewing session, a time variant cap that defines the maximum duration of the content viewing session for the hour, or a set top box classification.

4. The method of claim 1, further comprising determining a percentile cap of the content output threshold based on a network type or a time of a day.

5. The method of claim 1, further comprising determining a time variant cap of the content output threshold based on at least one of: the network type, a time of a day, or a minute of a day.

6. The method of claim 1, further comprising determining a set top box classification of the content output threshold based on at least one of: historical data associated with a likelihood of viewing the content item, an expected duration of a content viewing session associated with the content item, a time point of the content viewing session, or power data of the set top box, wherein the set top box classification comprises a reliable classification or an unreliable classification.

7. The method of claim 1, wherein the viewing characteristic comprises at least one of: a percentile rank of a viewing length of the content viewing session, an hour within a twenty four hour period, or historic viewing length data.

8. The method of claim 1, wherein determining the false positive event comprises iteratively determining, based on at least one of: a correlation parameter, an error parameter, or a root mean square error (RSME) parameter, a maximum session length parameter of the content output threshold.

9. The method of claim 1, wherein the content output threshold comprises a duration of the content viewing session indicative of a viewer being absent for at least a portion of the content viewing session.

10. The method of claim 1, wherein the false positive viewing event comprises an indication of a content viewing device being powered on and the absence of a viewer corresponding to the content viewing device, and wherein the content viewing device is associated with the delivery of the content item.

11. A method comprising:
determining, based on content viewership data, a start time of a delivery of a content item and an end time of the delivery of the content item;
determining, based on the start time and the end time, a content viewing session;
determining, based on a viewing characteristic of the content viewing session and a grid search associated with a content output threshold for an hour of a plurality of hours, a false positive viewing event, wherein the false positive viewing event is indicative of the content item being output and not viewed during the content viewing session;
receiving, based on the grid search, an adjustment to the content output threshold for the hour;
removing, based on the adjustment to the content output threshold, the false positive viewing event from a viewership statistic.

12. The method of claim 11, further comprising determining the content output threshold for an hour of a plurality of hours, wherein the content output threshold comprises at least one of: a cap threshold that defines a maximum duration of a context viewing session, a percentile cap that defines a maximum percentile of a duration of the content viewing session, a time variant cap that defines the maximum duration of the content viewing session for the hour, or a set top box classification.

13. The method of claim 11, wherein the content output threshold comprises a duration of the content viewing session indicative of a viewer being absent for at least a portion of the content viewing session.

14. The method of claim 11, wherein the false positive viewing event comprises an indication of a content viewing device being powered on and the absence of a viewer corresponding to the content viewing device, and wherein the content viewing device is associated with the delivery of the content item.

15. A method comprising:
receiving, by a computing device, a viewership statistic;
determining content metadata associated with sending a content item for a content viewing session, wherein the content metadata comprises a start time of a delivery of a content item and an end time of the delivery of the content item;
determining, based on comparing a viewing characteristic of the content viewing session to a content output threshold, an adjustment to a viewing event, wherein the adjustment to the viewing event is indicative of the content item being output and not viewed during the content viewing session; and
adjusting, based on the adjustment to the viewing event, the viewership statistic.

16. The method of claim 15, wherein adjusting the viewership statistic comprises removing a false positive event from the viewership statistic.

17. The method of claim 15, further comprising determining, based on a network type, at least one of: a scale parameter, a fit parameter, and an error parameter associated with the viewership statistic.

18. The method of claim 15, further comprising determining the content output threshold for an hour of a plurality of hours, wherein the content output threshold comprises at least one of: a cap threshold that defines a maximum duration of a context viewing session, a percentile cap that defines a maximum percentile of a duration of the content viewing session, a time variant cap that defines the maximum duration of the content viewing session for the hour, or a set top box classification.

19. The method of claim 15, wherein the content output threshold comprises a duration of the content viewing session indicative of a viewer being absent for at least a portion of the content viewing session.

20. The method of claim 15, wherein the adjustment to the viewing event comprises an indication of a content viewing device being powered on and the absence of a viewer corresponding to the content viewing device, and wherein the content viewing device is associated with the delivery of the content item.
